(19) United States
(12) Patent Application Publication
(10) Pub. No.: US 2010/0259926 A1
(43) Pub. Date: Oct. 14, 2010

(54) LED LAMP HAVING AN IMPROVED HEAT SINK

(75) Inventors: YONG-DONG CHEN, Shenzhen City (CN); GUANG YU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/496,654

(22) Filed: Jul. 2, 2009

(30) Foreign Application Priority Data
Apr. 13, 2009 (CN) 200910301518.8

(51) Int. Cl. F21V 29/00

(52) U.S. Cl. 362/234

(57) ABSTRACT

An LED lamp includes a heat sink and an LED module mounted on the heat sink. The LED module includes a printed circuit board and a plurality of LEDs mounted on a top of the printed circuit board. The heat sink includes a hollow cylinder having a plurality of fins extending outwardly and blocks extending inwardly therefrom. The cylinder contacts with a bottom of the printed circuit board. The blocks are located corresponding to the LEDs so that the blocks are arranged in the cylinder in a pattern corresponding to that of the LEDs on the printed circuit board.

### BACKGROUND

1. Technical Field

The present disclosure relates to a light emitting diode (LED) lamp, and more particularly, to an LED lamp having an improved heat sink to facilitate heat dissipation thereof.

2. Description of Related Art

LEDs have been available since the early 1960's. LED use has increased in a variety of applications, such as in residential, traffic, commercial, and industrial settings, because of the high light-emitting efficiency of LEDs. A conventional LED lamp includes a heat sink functioning as a support and a plurality LEDs mounted on the heat sink. The heat sink may be configured having different shapes, however, a shape of hollow cylinder is commonly utilized in the art for its wide adaptability for various applications. For example, if an omnidirectional illumination is required, the LEDs could be distributed around an outer circumferential surface of the cylinder via multiple printed circuit boards, whereby the radiation from the LEDs would be diffused all over the surrounding environment; if a high directional illumination is desired, the LEDs could be arranged on an annular flat top or bottom surface of the cylinder via a printed circuit board so that the radiation from the LEDs would be concentrated into a single beam.

The LEDs generate a large amount of heat during operation. For the latter one where the LEDs are concentrated on the bottom or top surface of the heat sink, effective heat dissipation is more imperative due to limited contacting area between the annular top or bottom surface of the heat sink and the printed circuit board. A typical means of enhancing heat dissipation is to extrude multiple fins around the outer circumferential surface of the heat sink. Some lamps may further form multiple fins on an inner circumferential surface of the heat sink, which could increase heat dissipation areas of the heat sink as well as the contacting areas of the annular top or bottom surface of the heat sink with the printed circuit board.

However, since the thickness of the fin is relatively small, the contacting areas increased by the inner fins are still limited. On the other hand, when the LEDs are in operation, multiple spots of the printed circuit board corresponding to the LEDs would have higher temperature than other locations of the printed circuit board due to the heat is locally concentrated on the printed circuit board. Nevertheless, the inner fins are usually uniformly distributed in the heat sink to contact the printed circuit board evenly, the inner fins cannot pertinently remove heat from the multiple spots having the highest temperature. Thus, the hottest spots of the printed circuit board do not get enough heat dissipation, while other portions of the printed circuit board (generally having areas larger than those of the hottest spots) which have temperature lower than that of those spots, are given much more cooling. This results in unbalance of distribution of heat dissipation to the LEDs. Accordingly, the heat dissipation performance of the heat sink is affected, causing the heat sink falling short of heat dissipation requirements of high power LEDs.

What is needed, therefore, is an LED lamp which can overcome the above-mentioned disadvantages.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a top view of an assembled LED lamp of a first embodiment of this disclosure.

FIG. 2 is an exploded view of the LED lamp of FIG. 1.

FIG. 3 shows a cross-sectional view of the LED lamp of FIG. 1.

FIG. 4 shows an exploded view of an LED lamp of a second embodiment of this disclosure viewed from a top aspect.

FIG. 5 shows an exploded view of an LED lamp of a third embodiment of this disclosure viewed from a top aspect.

FIG. 6 shows an exploded view of an LED lamp of a forth embodiment of this disclosure viewed from a top aspect.

### DETAILED DESCRIPTION

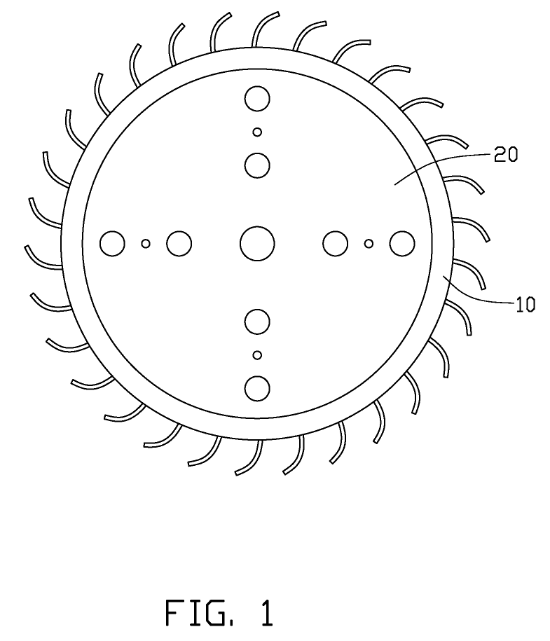

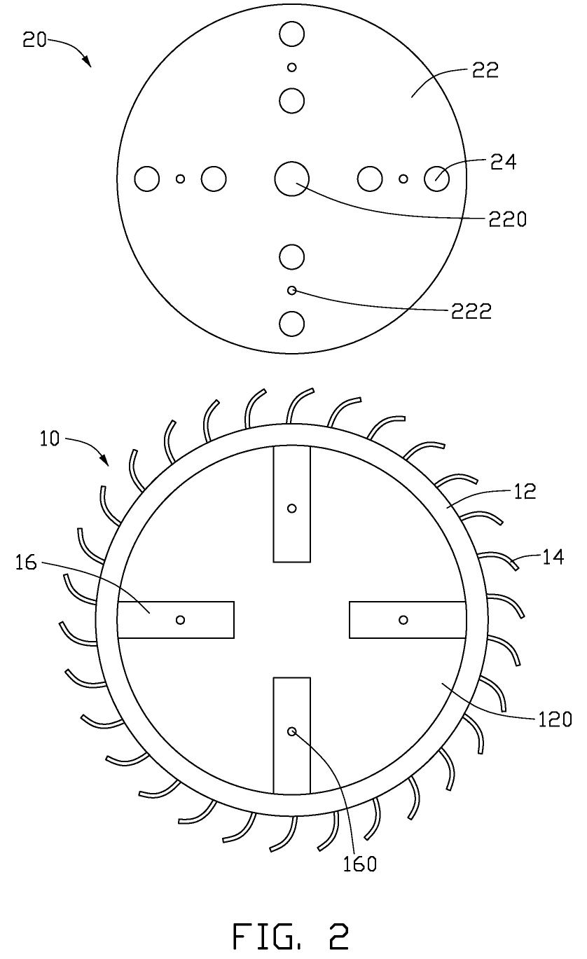

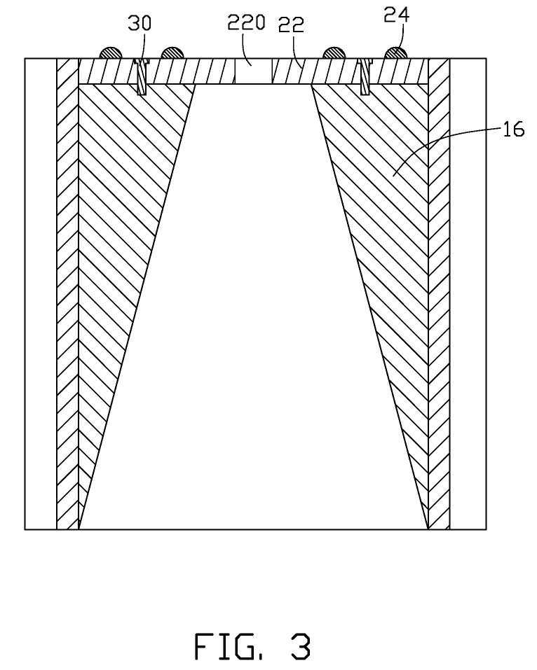

Referring to FIGS. 1-3, an LED lamp in accordance with a first embodiment of the disclosure is illustrated. The LED lamp includes a heat sink 10 and an LED module 20 mounted on a top of the heat sink 10. The LED module 20 includes a circular printed circuit board 22 and four groups of LEDs 24 mounted on a top surface of the printed circuit board 22. A circular hole 220 is defined in a center of the printed circuit board 22. The four groups of LEDs 24 are arranged on the printed circuit board 22 in a crossed manner that the top surface of the printed circuit board 22 are divided into four identical parts by the four groups of LEDs 24; that is to say, every two neighboring groups of LEDs 24 define an angle of 90 degrees therebetween. Each group of LEDs 24 includes two spaced LEDs 24 arranged along a radial direction of the printed circuit board 22. A through hole 222 is defined between the two LEDs 24 of each group for extension of a screw 30 (see FIG. 3) through the printed circuit board 22.

The heat sink 10 is integrally made of a kind of metal such as copper or aluminum or other suitable materials. The heat sink 10 includes a hollow cylinder 12 with an opening 120 extending therethrough along a bottom-top direction. A plurality of fins 14 are extended radially from an outer circumference of the cylinder 12. Four blocks 16 are extended inwardly from an inner circumference of the cylinder 12 to directly contact a bottom surface of the printed circuit board 22. The four blocks 16 are located corresponding to the four groups of LEDs 24, wherein each block 16 has a rectangular top surface, on which a corresponding group of LEDs 24 overlays, whereby all of the LEDs 24 are in thermal connection with the blocks 16. Thus, when the LEDs 24 are in operation, heat concentrated in hottest spots of the printed circuit board 22 could be timely conducted by the blocks 16 to the fins 14, thereby improving heat dissipation performance of the LEDs 24. Furthermore, since the thickness of the block 16 is far larger than that of the fin 14, the block 16 could have sufficient area to contact the printed circuit board 22. The four blocks 16 are spaced from each other at their innermost extremities to leave a passage in the center of the heat sink 10. A threaded hole 160 is defined in each block 16 corresponding to the through hole 222 in the printed circuit board 22, whereby the screws 30 could extend through the printed circuit board 22 into the blocks 16 to thereby secure the LED module 20 on the heat sink 10. Each block 16 has a length gradually increased from the bottom-top direction of the heat sink 10 so that each block 16 has a triangle profile viewed from a front side thereof, as shown in FIG. 3. Alternatively, each block 16 could also have a fixed length to increase heat dissipation capability of the heat sink 10.

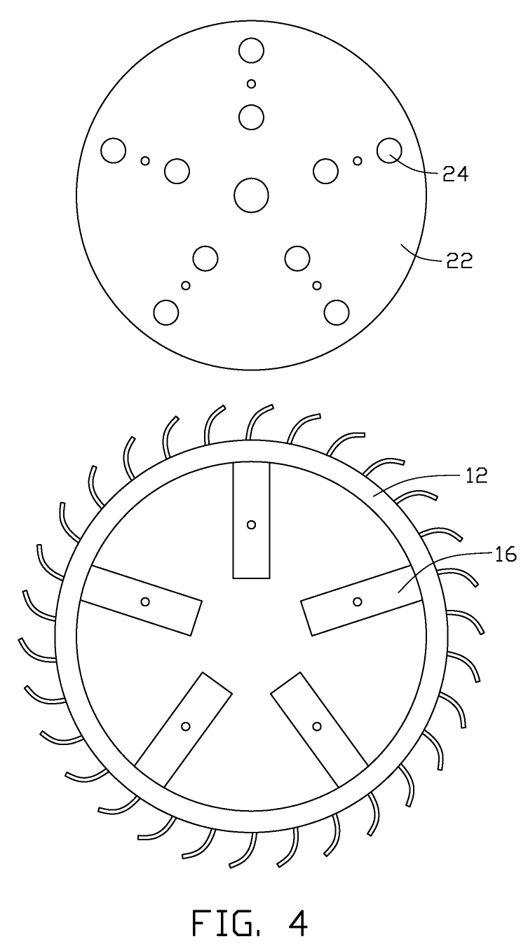

It is noted that the number of the blocks 16 is variable depending on the particular type of the LED module 20 where the LEDs 24 may arranged in various patterns. For example, the heat sink 10 may have five blocks 16 uniformly formed in the opening 120 according to a stellated pattern of the LEDs 24 on the printed circuit board 22 as shown in FIG. 4.

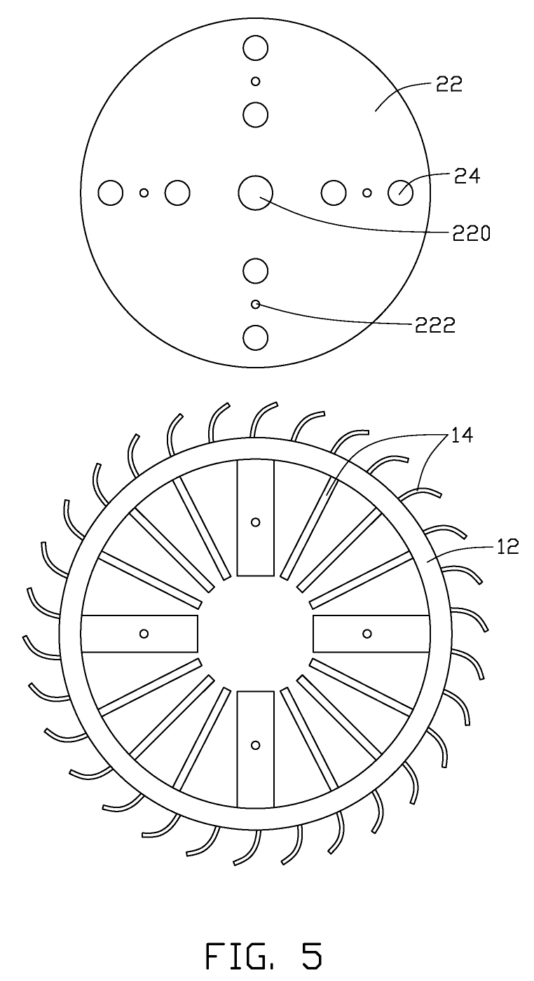

Furthermore, the heat sink 10 of FIGS. 1-3 could further form a plurality of fins 14 extending inwardly from the inner circumference of the cylinder 12 as shown in FIG. 5, to thereby more effective dissipate heat from the LEDs 24.

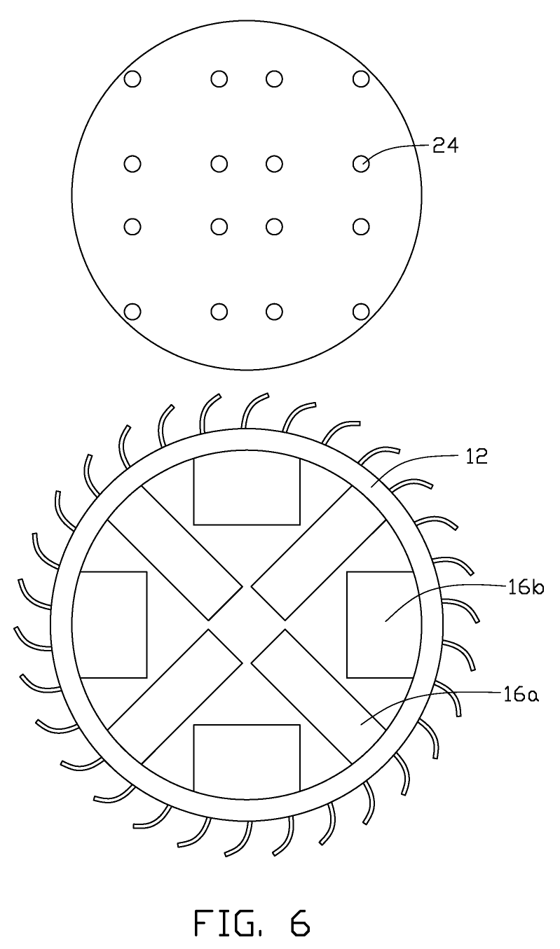

The blocks 16 shown in FIGS. 1-5 are all extended along radial directions of the heat sink 10 and have the same length and width, due to that the LEDs 24 are arranged in radial directions of the printed circuit board 22; however, when the LEDs 24 are arranged in a different pattern, such as a matrix, not only the number of the blocks 16 but also the widths and lengths of the blocks 16 have to be varied so that all of the LEDs 24 can have a thermal connection with the blocks 16. An example of the matrix pattern of the LEDs 24 is shown in FIG. 6, wherein two different types of blocks 16a, 16b are provided in the opening 120 of the heat sink 10. The first type of blocks 16a includes four first blocks 16a alternately arranged with four second blocks 16b of the second type of blocks 16b. The first blocks 16a are extended radially toward a center of the heat sink 10, wherein each first block 16a has a length larger or at least equal to a distance between two adjacent LEDs 24 located in diagonals of the matrix so that each first block 16a corresponds to two adjacent LEDs 24 in the diagonals of the matrix of the LEDs 24. The second blocks 16b are also extended radially, wherein each second block 16b has a width larger or at least equal to a distance between two adjacent LEDs 24 located in a middle of each of four sides of the matrix so that each second block 16b also corresponds to two adjacent LEDs 24. Therefore, all of the LEDs 24 in the matrix are thermally connected by these blocks 16a, 16b. The second block 16b has a length less than that of the first block 16a, and a width larger than that of the first block 16a, thereby preventing interference between each other.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

1. An LED (light emitting diode) lamp comprising:
a printed circuit board having a plurality of LEDs mounted thereon; and
a heat sink comprising a hollow cylinder having an opening therethrough;
wherein the heat sink has multiple blocks extending in the opening, the blocks being in thermal contact with the printed circuit board and arranged corresponding to locations of the LEDs.

2. The LED lamp as claimed in claim 1, wherein the heat sink has a plurality of fins extending outwardly from an outer circumference of the cylinder, each of the blocks having a thickness larger than that of each of the fins.

3. The LED lamp as claimed in claim 2, wherein the heat sink further has a plurality of additional fins extending inwardly from an inner circumference of the cylinder, the additional fins being located between the blocks.

4. The LED lamp as claimed in claim 1, wherein each of the blocks has a top surface on which at least one LED overlays.

5. The LED lamp as claimed in claim 4, wherein the blocks have first blocks extended in the opening of the heat sink along radial directions of the heat sink.

6. The LED lamp as claimed in claim 5, wherein the blocks are arranged in a pattern so that all of the LEDs arranged on the printed circuit board overlay top surfaces of the blocks.

7. The LED lamp as claimed in claim 6, wherein the LEDs are mounted on the printed circuit board in a crossed manner that the printed circuit board are divided by the LEDs into four identical parts.

8. The LED lamp as claimed in claim 5, wherein the blocks have second blocks extending in the opening of the heat sink, each second block having a width larger than that of each first block and a length smaller than that of each first block.

9. The LED lamp as claimed in claim 8, wherein the first blocks and second blocks are alternately arranged.

10. The LED lamp as claimed in claim 9, wherein the LEDs are arranged on the printed circuit board in a matrix.

11. The LED lamp as claimed in claim 1, wherein each of the blocks has a length increasing along a bottom-top direction of the heat sink.

12. An LED (light emitting diode) lamp comprising:
a printed circuit board having a plurality of LEDs mounted thereon;
a heat sink comprising a hollow cylinder with an opening therethrough;
wherein the heat sink comprising a plurality of blocks extending inwardly from an inner circumference of the cylinder, the blocks being in thermal contact with the printed circuit board; and
wherein each of the LEDs is substantially located within a periphery of a top surface of one of the blocks of the heat sink.

13. The LED lamp as claimed in claim 12, wherein the blocks comprise first blocks extending radially in the opening of the heat sink.

14. The LED lamp as claimed in claim 13, wherein the first blocks are arranged in the same pattern as that of the LEDs arranged on the printed circuit board.

15. The LED lamp as claimed in claim 13, wherein the blocks further comprise second blocks, each second block having a width larger than that of each first block.

16. The LED lamp as claimed in claim 15, wherein the second blocks are alternately arranged with the first blocks, each of the first blocks having a length larger than that of each second block.

17. The LED lamp as claimed in claim 16, wherein the LEDs are mounted on the printed circuit board in a matrix.
